(19) United States
(12) Patent Application Publication
(10) Pub. No.: US 2024/0140691 A1
(43) Pub. Date: May 2, 2024

(54) BIOLOGICALLY DEGRADABLE PORTION CAPSULE

(71) Applicant: Tchibo GmbH, Hamburg (DE)

(72) Inventor: Norbert Kuhl, Salzburg (AT)

(21) Appl. No.: 18/548,602

(22) PCT Filed: Mar. 4, 2022
(86) PCT No.: PCT/EP2022/055614

§ 371 Date: Sep. 1, 2023

(30) Foreign Application Priority Data
Mar. 5, 2021 (EP) 21161097.7

(51) Int. Cl. B65D 85/808; B65D 65/46

(52) U.S. Cl. CPC B65D 85/8085; B65D 65/466; B65D 17/44

(57) ABSTRACT

A portion capsule includes a peripheral side wall, a first cover element and a second cover element, wherein the peripheral side wall, the first cover element and the second cover element form a closed interior. The first cover element and/or the second cover element include an arching directed into the interior. At least the cover element including the arching is manufactured of a biologically degradable material.

### BACKGROUND OF THE INVENTION

### Field of the Invention

The invention lies in the field of devices and methods for preparing drinks by way of a fluid which is introduced into a drinks capsule, wherein the drinks capsule includes a soluble foodstuff substance, from which a drink or drinks constituent can be prepared by way of injecting water. In particular, the invention lies in the field of preparing coffee amid the use of a coffee capsule. The invention in particular relates to a portion capsule, a drinks preparation machine which is adapted to the portion capsule according to the invention, as well as a method for the operation of a drinks preparation machine amid the use of a portion capsule according to the invention.

### Description of Related Art

Amongst the systems for preparing drinks, so-called coffee capsule systems are known (these are also available in variants for the preparation of tea), concerning which generally hot water mostly under pressure in introduced into a capsule, in order to prepare a coffee drink or tea drink by way of extraction. For introducing the hot water, the capsule is often pierced at the one side (injection side). Various possibilities are known for leading out the brewed drink, generally at the other side of the capsule (the extraction side). On the one hand there are systems, concerning which a piercing by way of suitable perforation spikes is also envisaged at the extraction side. On the other hand, systems are known, concerning which an extraction-side delimitation of the capsule is pierced or torn under the inner pressure during the brewing process, for which means which are external to the capsule (present in the brewing chamber of the respective coffee machine) or capsule-internal means can be present.

Finally, there are also capsules which are already open, with regard to which therefore no capsule wall/membrane needs to be pierced or torn in order to discharge the drink.

Most widespread are capsules of materials which are neither biologically degradable nor consist of renewable raw materials. The capsules to a high degree consist, for example, of aluminium or of plastic, for example polypropylene (PP). Such capsules can have advantageous characteristics for the storage (e.g., sealedness, in particular air/oxygen impermeability) as well as for the use (e.g., thermal shape-stability, piercing behaviour, etc). A great disadvantage of these capsules is the waste which occurs after use or the necessary high effort for the re-utilisation of the materials which are used in the capsules. The latter entails the collection of the capsules which as a rule are used in the private household, the transport of these to recycling facilities and the recycling process itself. In other words, even for the recycling, significant resources (time, energy but also transport costs) need to be consumed, which in turn can burden the environment (e.g., CO₂ emissions on transport and for obtaining the energy which is necessary for the recycling). Furthermore, as a rule, the extraction material which is contained in the capsule is also lost with the recycling.

The use of less resource-intensive materials for portion capsules is known per se. In particular, the application of bio-plastics has been discussed. On the one hand, plastics which are manufactured of a renewable raw material (so-called bio-based plastics) are denoted as such. On the other hand, bio-plastic are plastics which are biologically degradable (so-called biodegradable plastics).

In the present text “biodegradable” means biologically degradable according to the standard EN13432 (Status: end of 2019), and “bio-based” means “from renewable raw materials, not based of fossils”.

Apart from the application of biodegradable and/or bio-based plastics, composite materials which are biodegradable and/or bio-based and include a share of bio-based additives have been developed and are being developed in the packaging industry. Herein, a biodegradable and/or bio-based plastic forms the plastic component (also called plastic matrix) and a bio-based additive forms the filler.

US 2018/0127554 A1, US 2012/0071591 A1 and J Mater Sci (2018) 53:10920-10932 provide an overview to such composite materials which amongst other things are considered for the application in packaging in the foodstuff industry. As a rule, bio-plastics such as, for example, polylactide (PLA), polybutylene adipate terephthalate (PBAT), polybutylene succinate (PBS) and poly(butylene succinate-co-adipate) (PBSA) form the plastic components during the discussion of various bio-based fillers.

Alternatively to bio-plastics and the mentioned composite materials, concerning which a bio-plastic is used for example in combination with a bio-based filler, the application of packaging which completely or to a great extent consist of a bio-based material have been put forward. For example, WO 2015/170358 A2 teaches the application of materials which have been obtained from wood, for containers and capsules.

It has been found that the aforementioned bio-plastics, composite materials and bio-based materials can only be considered for the application in portion capsules to a limited extent. A disadvantage of the mentioned bio-plastics, composite materials and bio-based materials lies in the fact that these have physical characteristics, for example sealedness, in particular air/oxygen impermeability, thermal shape-stability, stiffness or brittleness (piercing behaviour) which are unsuitable for an application in portion capsules and the preparation process entailed by this. In particular, they are inferior to other materials with regard to the physical characteristics and with a view to the use in portion capsules and the preparation process which this entails. An adaptation of the physical characteristics of the bio-plastics, composite materials and bio-based materials to an application in portion capsules—if indeed such an adaptation were to be possible at all—would lead to the base material of the portion capsule which is to say the applied bio-plastic, the applied composite material or the applied bio-based material requiring much effort in manufacture and becoming expensive.

For example, WO 2017/186743 A1 teaches the use of a bio-material, amongst other things for coffee and tea capsules, wherein the bio-material includes a biologically degradable plastic and sunflower seed hulls or sunflower seed husks. The sunflower seed shells or the sunflower seed husks must be processed before the compounding with the biologically degradable plastic. In particular, apart from the actual extraction of the sunflower seed hulls or sunflower seen husks, a size reduction, drying and de-oiling are necessary. According to the teaching of WO 2017/186743 A1, the mentioned bio-material has physical characteristics which make these more suitable than other biologically degradable plastics, in particular for the application in coffee capsules or tea capsules.

Other approaches according to the state of the art are directed towards the remedying of the aforementioned disadvantages which result from the physical characteristics of the bio-plastics, composite materials and bio-based materials in another manner, which is to say not by way of adapting the characteristics, in order despite this to be able to use these materials in portion capsules. As a rule, such approaches significantly increase the expense in manufacturing the portion capsule.

DE 202016104950 U1 teaches a hermetically closable portion package or a hermetically closable portion sachet with a biologically degradable capsule or a biologically degradable pad, wherein the portion package or the portion sachet consist completely of biologically degradable material. The package or the sachet includes two foils which are connected to one another, in order to bring the physical characteristics closer to the requirements with regard to portion capsules. In other words, the disadvantages which are inherent of the bio-plastics, composite materials and bio-based materials with regard to an application in portion capsules are remedied somewhat by way of the portion capsule being brought into a multi-layered package, for example a multi-layered sachet, wherein the layers ensure that the total system of “package/sachet and portion capsule” have characteristics which permit the application in the field for drinks preparation.

WO 2011/015973 A1 teaches a capsule which consists completely of biologically degradable material, wherein the realisation of the membrane which closes the capsule is at the forefront of the teaching of WO 2011/015973. The membrane is reinforced by an additional element, in order to permit the application of the applied biologically degradable material in the field of drinks preparation.

### SUMMARY OF THE INVENTION

It is an object of the present invention to remedy one or more of the aforementioned disadvantages with regard to the portion capsules according to the state of the art.

In particular, it is the object of the invention to provide portion capsules of a biologically degradable base material which with respect to the physical characteristics as well as the manufacture can compete to an improved extent with the portion capsules of other materials. The “other” materials in particular can be:
non-biologically-degradable or for the most part not biologically degradable; and/or
require more effort concerning the production of material; and/or
be of a nature such that for an application in portion capsules, disadvantageous characteristics are compensated via additional elements of the portion capsule or via elements which are additional to the portion capsule. This means that the “other” materials can be of a nature such that the capsule manufacture requires more effort.

In particular, it is an object of the invention to provide a portion capsule of a base material which given an overall consideration which includes physical characteristics and the expense on manufacture is superior to portion capsules of biologically degradable material according to the state of the art.

Furthermore, it is an object of the invention to provide a drinks preparation machine which is adapted to the portion capsule according to the invention as well as a method for the operation of a drinks preparation machine amid the use of a portion capsule according to the invention.

A disadvantage which prevents the application of many biologically degradable materials, for example the aforementioned bio-plastics, composite materials and bio-based materials in portion capsules for drinks preparation is their piercing behaviour during the preparation process. It is particularly this disadvantage which is to be reduced by the portion capsule according to the invention.

Many biologically degradable materials are brittle in comparison to other materials which are used with portion capsules, such as for example aluminium. This leads to the portion capsules being pierced prematurely by the injection-side piercing device and/or extraction-side piercing device, which is to say too early within the preparation process, in particular before the water pressure which is required for the desired extraction and/or the temperature which is required for the desired extraction is present.

In contrast to the approaches according to the state of the art, for example WO 2017/186743 A1 or the document US 2018/0127554 A1 which does not relate to portion capsules, the physical characteristics of many biologically degradable materials which are problematic with respect to the piercing behaviour, according to the invention are not dealt with or not only dealt with by a suitable adaptation of the materials via their composition, but via the shape and the behaviour of parts of the portion capsule during the preparation process. In other words, the portion capsule according to the invention has structural features which reduce the disadvantages of the use of biologically degradable materials for portion capsules.

The use of structural features in order to give the portion capsule a specific characteristic, in itself is nothing new and is applied in particular with portion capsules which are neither biologically degradable nor include renewable raw materials. For example, US 2020/0180856 A1, WO 2005/066040 A2, DE 20 2005 021 174 U1 and DE 10 2012 105 282 A1 disclose portion capsules with specific structural features. However, with regard to the structural features which are disclosed in the state of the art, these are not features which are designed in view of compensating problematic characteristics of the used, biologically degradable material.

A portion capsule according to the invention includes a peripheral side wall, a first cover element and a second cover element, wherein the peripheral side wall, the first cover element and the second cover element are arranged to one another in a manner such that a closed interior is formed.

The first cover element or the second cover element includes an arching which is directed into the interior, wherein the cover element which includes the arching is manufactured of a biologically degradable material.

In an embodiment, both cover elements include an arching in one of the subsequently described embodiments. Accordingly, both cover elements can also be manufactured of a biologically degradable material.

In an embodiment, the cover element which includes the arching and the peripheral side wall are manufactured of a biologically degradable material.

In particular, the cover element which includes the arching and the peripheral side wall can be manufactured of the same biologically degradable material. In particular, this can be the case if the mentioned cover element and the peripheral side wall form the subsequently described base element.

In an embodiment, the first cover element, the second cover element and the peripheral side wall are manufactured of a biologically degradable material, in particular of the same biologically degradable material. Optionally, further elements of the portion capsule, for example the subsequently described filter element can be manufactured of a biologically degradable material.

In an embodiment, the complete portion capsule is manufactured of a biologically degradable material. Optionally, the complete portion capsule can be manufactured of the same biologically degradable material.

As a rule, the first cover element is a bottom element and the second cover element is a lid element of the portion capsule or vice versa.

In many embodiments, the peripheral side wall and one of the two cover elements, for example the first cover element, particularly if it is a bottom element, is a base element of the portion capsule. In other words, the portion capsule has a base element which includes the peripheral side wall and one of the two cover elements.

The other of the two cover elements, for example the second cover element, particularly is a lid element is then fastened to the base element such that the base element and the other of the two cover elements form the interior.

For example, the base element can form a peripheral flange and the other of the two cover elements, which is to say that cover element which is not part of the base element, can be fastened to the base element along the peripheral flange.

In contrast to the cover element which is not part of the base element, the cover element which is part of the base element as a rule is already connected to the peripheral side wall on being formed. In particular, the base element can be formed from one piece.

In an embodiment, the base element includes the arching. This means that that cover element which is part of the base element includes the arching.

The cover element which includes the arching or the base element, in the case that the cover element which includes the arching is part of the base element, can be shaped out in a way and manner which is known for the manufacture of portion capsules, in particular by way of injecting moulding or deep-drawing. Given the application of such manufacturing methods, the manufacture of a portion capsule according to the inventions does not or at least not significantly require more effort or expense than the manufacture of portion capsules according to the state of the art which are not biologically degradable, and its becomes simpler and less expensive than the manufacture of biologically degradable portion capsules, concerning which the physical characteristics which are disadvantageous for an application with a portion capsule are not compensated in accordance with the invention.

In particular, the arching is an arching which is visible when viewing the capsule from the outside.

In particular, the arching is an arching which extends in the direction of the interior from a plane which is defined by a peripheral transition region from the cover element which includes the arching to the peripheral side wall.

The preparation of a brewed drink amid the use of a portion capsule according to the invention takes place in a drinks preparation machine which includes a brewing module. The brewing module includes a first brewing module part and a second brewing module part which is movable relative to this, wherein a brewing chamber can be formed by the first and second brewing module part, said brewing chamber during the brewing procedure at least partly surrounding the portion capsule which is situated in the brewing position. The brewing module is configured to brew a brewed drink by way of introducing a brewing fluid into the portion capsule and to discharge this out of the brewing module. For this, the brewing module includes an injection-side piercing device and an extraction-side piercing device.

Concerning drinks preparation machines of this type, a portion capsule which is inserted into the open brewing chamber gets into the brewing position by way of the second brewing module part being moved along an axis of the brewing chamber towards the first brewing module part. Concerning drinks preparation machines according to the state of the art, by way of this the injection-side piercing device comes into contact with that cover element, via which the brewing fluid is introduced into the portion capsule, and the extraction-side piercing device with that cover element, via which the brewed drink is discharged. On coming into contact, the injection-side piercing devices exert a force upon the respective cover element, which leads to one (or more) injection-side piercing tip(s) penetrating the cover element. At least one extraction-side piercing tip of the extraction-side piercing device simultaneously exerts a force upon the respective cover element, said force leading to a deformation of the cover element but not to it being penetrated. The penetration itself, at least in the case of high-quality drinks preparation systems and portion capsules which are adapted to these, does not take place until a pressure which is suitable for the brewing process prevails in the interior. Otherwise, for example in a first phase of the preparation process, a brewed drink which is qualitatively insufficient is prepared due to the fact that the parameters which are required for the brewing process, in particular the pressure, temperature and throughput quantity do not prevail in the interior but despite this brewed drink would be led out of the portion capsule.

If now the cover element, via which the brewed drink is discharged, consists of a biologically degradable material, the force which occurs on closing the brewing module, which is to say with the bringing of the portion capsule into the brewing position, would lead to the cover element via which the brewed drink is discharged being penetrated. This is due to the fact that the physical characteristics of the biologically degradable material, in particular its brittleness, are conducive to the tearing-open of the cover element.

On account of these facts, on preparation of a brewed drink amid the use of a portion capsule, the arching of a portion capsule according to the invention can extend in particular so far into the interior, which is to say extend way from the aforementioned plane, that the extraction-side piercing device, in particular a piercing tip of this cannot puncture the cover element in the region of the arching or not penetrate it to the extent as would be necessary of the discharge of the brewed drink. In other words, on transition into the brewing position, the cover element only comes into contact with the end region of the piercing device which projects into the brewing chamber, for example only with the end region of the piercing tip which projects into the brewing chamber, or the cover element does not come into contact with the piercing device at all, but this piercing device only comes to lie within the arching.

Concerning a method for the operation of a drinks preparation, the method being adapted to a portion capsule according to the invention, the extraction-side piercing device, in particular a piercing tip of this only penetrates the respective cover element in a manner which is suitable for a discharge of the brewed drink out of the portion capsule, when a minimally required pressure for the brewing process is present in the interior of the portion capsule, by way of this pressure ensuring that the arching flattens. In other words, the portion capsule and a drinks preparation machine which is adapted thereto, in particular its brewing module are configured such that a penetration of the cover element having an arching at the beginning, the penetration being suitable for the discharge of the brewed drink out of the portion capsule, does not take place until a minimally required pressure for the brewing process is present in the interior of the portion capsule by way of this pressure ensuring that the arching flattens.

The flattening of the arching represents a deformation of that cover element which has the initial arching before the insertion of the portion capsule into the brewing chamber. The deformation can go beyond a simple flattening of the arching and for example include the following: a folding-over of the cover element or a part thereof and/or the formation of a collection region and/or the formation of a topography which is conducive to the leading of the brewed drink to a location at which the brewed drink is discharged out of the capsule interior.

As to whether and to what extent the cover element including the arching is penetrated when the portion capsule is located in the brewing position and the brewing process has not yet been started can a depend on the selected way and manner in which the brewed drink is discharged out of the portion capsule:
If the extraction-side discharge device is configured to discharge the brewed drink via one or more extraction-side piercing tips by way of these having a channel lying inside them and one or more channel openings, via which the brewed drink can get into the channel lying at the bottom, then the extraction-side piercing tip can penetrate the cover element, wherein the piercing tip does not project so far into the inside of the capsule that the channel opening comes to lie in the inside of the capsule.
Of course, one can completely make do without a penetration of the cover element even given an extraction-side piercing device with a channel lying at the bottom and channel openings.
If the extraction-side discharge device is configured to discharge the brewed drink around the piercing tip or piercing tips, then the arching and the extraction-side piercing tip(s) should be matched one another such that the extraction-side piercing tip(s) does (do) not penetrate the cover element or only rudimentarily.
If the extraction-side piercing tip(s) only serves (serve) for opening the capsule and does (do) not otherwise directly contribute to the discharge of the brewed drink, then the arching and the extraction-side piercing tip(s) should be matched to one another in a manner such that the extraction-side piercing tip(s) does (do) not penetrate the cover element.

As to whether and to what extent the extraction-side piercing tip penetrates the cover element which includes the arching, when the portion capsule is situated in the brewing position and the brewing process has not yet been started, as a rule depends on the design of the arching and of the extraction-side piercing device, in particular on the extent to which the extraction-side piercing tip(s) projects (project) into the brewing chamber.

In particular, the arching flattens when the region of the cover element which makes up the arching moves in the direction of the plane which is defined by a peripheral transition region from the cover element which includes the arching to the peripheral side wall. In other words, the arching flattens, in particular when the region of the cover element which makes up the arching moves in the direction of the piercing device.

The cover element can be configured such that the flattening does not occur until a certain pressure prevails in the interior. This can be realised for example via at least one of the subsequent measures: the curvature of the arching; the thickness of the cover element; the material of the cover element; an element, in particular an element of the cover element which given a certain force action goes from a first state into a second state.

The flattening at least in a part region of the initial arching can end in a folding-over of the initial arching. This means that at least a part-region of the cover element which was part of the initial arching can be arched outwards, which is to say away from the interior, after the flattening.

The flattening can be effected partially or completely by an element of the portion capsule which is arranged in the interior and which can exert a force upon the cover element.

In an embodiment, the portion capsule includes a filter element which is arranged in the interior and which separates an extraction material region from the first cover element or from the second cover element, wherein that cover element which is separated from the extraction material region by the filter element includes the arching directed into the interior.

The filter element can be arranged in the interior in a manner such that it can move in the direction of the cover element which includes the arching and exert a force upon this cover element.

In an embodiment of the portion capsule with a filter element, the portion capsule includes a positioning device for the filter element, the positioning device being arranged relative to the filter element in a manner such that a movement of the filter element in the direction of the cover element which is separated from the extraction material region by the filter element, which is to say in the direction of the cover element which includes the arching, is not prevented.

In other words the positioning device permits a movement of the filter element to towards the cover element which includes the arching.

The positioning device can additionally be arranged relative to the filter element in a manner such that a movement of the filter element in the direction of that cover element which is not separated from the extraction material region by the filter element is prevented.

Embodiments of the portion capsule with filter element and optionally with a positioning device for the filter element can additionally include at least one of the following features:
The filter element separates the extraction material region from a collection region, in order to prevent extraction material from getting into the discharged brewed drink in an undesired manner.
The collection region can be delimited by the cover element which at the beginning of the preparation process has the initial arching, and by a surface of the filter element which is directed against this cover element.
The cover element which at the beginning of the preparation process has the initial arching can have a shape which delimits a collection region which lies between the filter element and cover element, even after the flattening of the arching which optionally has been accompanied, caused or contributed to by a movement of the filter element in the direction of the mentioned cover element.
The filter element can include a central element. This can include, for example, a projection of the filter element towards the extraction material region.
The portion capsule can be designed in a manner such that the brewed drink is only led away via the central element.
The cover element which has the initial arching at the beginning of the preparation process can have a shape which creates a collection region which lies between the filter element and the cover element and which permits a feed of the brewed drink which passes through the filter element, to the central element, even after the flattening of the arching which optionally has been accompanied, caused or contributed to by a movement of the filter element in the direction of the mentioned cover element.
For example, the cover element after its flattening, in the region of the central element can be arched outwards, which is to say in the direction of the adjacent brewing module part.
Alternatively or supplementarily, the cover element after its flattening can have a topography, concerning which the filter element does not lie on the cover element in an extensive manner and/or concerning which a feed of the brewed drink which passes through the filter element, to the central element, is encouraged, for example by way of brewed drink which passes through the filter element being led towards the central element.
In embodiments, in which the filter element includes the central element, the central element can be arranged in a manner such that an extraction-side piercing tip comes to lie in the central element given the flattening of the arching.
For example, the portion capsule can have a longitudinal axis which runs through the first and second cover element and about which the position capsule is essentially rotationally symmetrical.
The apex point of the arching and central element can then be arranged along an axis which runs parallel to the mentioned longitudinal axis.
Furthermore, after bringing the portion capsule into the brewing chamber, the piercing tip can be arranged along said axis which runs parallel to the longitudinal axis.
In particular, in embodiments, in which the portion capsule has only one arching, the mentioned axis which runs parallel to the longitudinal axis can be the longitudinal axis itself.
A plurality of spacers can be arranged in the collection region, the spacers limiting the movement of the filter element in the direction of the cover element which has the arching at the beginning.
The portion capsule can include a distributing element. This element is arranged in the interior and delimits the extraction material region towards an injection side, so that a distributing region is defined.

As already mentioned, the portion capsule can extend along a longitudinal axis which is an axis of symmetry of the portion capsule. As a rule, the longitudinal axis runs through the first and second cover element, or through the bottom element and lid element, or through the surface which is penetrated for the purpose of extraction and injection.

The portion capsule can be shaped in a manner such that it is rotationally symmetrical at every rotation angle about the longitudinal axis.

However, the portion capsule can also be shaped such that it is only rotationally symmetrical at certain rotation angles, for example at a rotation angle of 90 or 180 degrees.

In an embodiment, the portion capsule has a rectangular, in particular square base shape.

Each of the previously and subsequently described embodiments of the portion capsule can have one of the just described base shapes.

The portion capsule according to any one of the embodiments can include features which correspond to features of the subsequently described drinks preparation machine and/or of the subsequently described method or are matched to these.

The invention further relates to a drinks preparation machine which is optimised for an application of a portion capsule according to the invention in any one of the embodiments.

As can be derived from that which has been previously stated, the drinks preparation machine has a brewing module which includes a first brewing module part and a second brewing module part which is movable relative to this, wherein a brewing chamber which given the brewing process at least partly surrounds the portion capsule located in a brewing position can be formed by the first and the second brewing module part. The brewing module is configured to brew a brewed drink by way of introducing a brewing fluid into the portion capsule and to discharge the brewed drink out of the brewing module via an extraction-side piercing device.

The brewing chamber is formed by a wall of the first and/or the second brewing module part and an extraction-side piercing tip of the extraction-side piercing device is arranged in a deepening of the wall.

The deepening of the wall in particular extends laterally to an axial axis of the extraction side piercing tip and beyond a width of the extraction-side piercing tip, wherein the width of the extraction-side piercing tip is an extension of the extraction-side piercing tip in a direction which runs laterally to the axial axis of the extraction-side piercing tip.

In order words, the deepening is not only formed by an end of a bore which is at the brewing chamber side, the bore serving for leading through the extraction-side piercing tip into the brewing chamber and being matched to the width of the extraction-side piercing tip, but the deepening forms an indentation in the wall, said indentation extending over the bore which is necessary for leading through the extraction-side piercing tip.

On account of this shape of the brewing chamber in the region of the extraction-side piercing device, it is ensured that the arching of the cover element of the portion capsule which has the initial arching at the beginning of the preparation process can deform in a way and manner which rules out the portion capsule, during the preparation process, returning back again into its initial shape which has the initial arching, or into a comparable shape, wherein said deformation includes a flattening of the arching.

In particular, the mentioned shape of the brewing chamber permits a folding-over of the arching from the arching which is directed into the interior into an arching which projects into the deepening.

Furthermore, the mentioned shape of the brewing chamber ensures that the cover element after its deformation projects outwards in the region of the piercing tip, by which means a collection region forms even with embodiments of the portion capsule with a filter element which can move in the direction of the cover element which has the initial arching at the beginning of the preparation process.

In embodiments, the drinks preparation machine includes at least one of the following features:
The wall of the brewing chamber which, given an inserted portion capsule, faces the cover element which at the beginning of the preparation process has the arching, can have a topography which encourages the discharge of the brewed drink in the case that the cover element assumes this topography after its shape change.
In particular, the topography can be of such a nature that the filter element does not lie extensively on the cover element and/or that a feed of the brewed drink which passes through the filter element, towards a central element of the filter element, is encouraged, for example by way of brewed drink which passes through the filter element being led towards the central element.
The extraction-side piercing tip projects into the brewing chamber beyond an edge of the deepening. This means that the extraction-side piercing tip is not sunk in the deepening but projects out of this.

The drinks preparation machine according to any one of the embodiments can include features which correspond to the features of the portion capsule and/or of the subsequently described method or are adapted to these.

The invention further relates to a method for the operation of a drinks preparation machine amid the use of a portion capsule according to the invention.

As can be derived from that which has been stated previously, the method includes a step of the provision of a portion capsule according to the invention, in any one of the embodiments.

As can likewise be derived from that which has been previously disclosed, the method can further include one or more of the following steps:
Inserting the portion capsule into a brewing chamber of the drinks preparation machine, wherein the brewing chamber is formed by a first brewing module part and a second brewing module part which is movable relative to this.
Closing the brewing chamber by way of the second brewing module part being moved relative to the first brewing module part.
This step corresponds to the already mentioned “bringing the inserted portion capsule into a brewing position by way of the second brewing module part being moved to the first brewing module part along an axis of the brewing chamber.
The step of the closing of the brewing chamber can consequently activate one or more of the following steps:
   Bringing an injection-side piercing device into contact with that cover element, via which the brewing fluid is introduced into the portion capsule.
   Supplementarily, the injection-side piercing device, in particular a piercing tip of this can penetrate the mentioned cover element.
   The injection-side piercing device, in particular a piercing tip of this can penetrate the mentioned cover element in a way and manner such that a brewing fluid can be introduced into the interior via the injection-side piercing device.
   Alternatively, the cover element can also be penetrated or penetrated in a manner which is suitable for introducing the brewing fluid, only after it has been ascertained that a brewed drink is to be produced amid the use of the inserted portion capsule. This for example can presuppose a manipulation by a user.
   Positioning an extraction-side piercing tip in a region of the arching which is accessible from the outside.
   This step can optionally include a bringing of the extraction-side piercing tip into contact with that cover element which at the beginning has the initial arching, which means with that cover element, via which the brewed drink is discharged from the portion capsule.
   The step can further optionally include a piercing of the cover element. As already mentioned, the step however does not include a puncturing of the cover element in a way and manner such that a liquid can be efficiently discharged out of the portion capsule without further steps, in particular without a deformation of the arching. In this context, a discharge would be efficient if for example the discharge were to be comparable with the discharge during the preparation of the brewed drink and/or if the discharge were to be of a nature such that it would prevent a sufficient pressure build-up in the interior and/or if the quantity of liquid which in a first phase of the preparation process, in which the conditions required for the brewing process do not yet prevail in the interior, were to be such that this quantity makes up a significant part of the finally produced brewed drink. As a rule, 2-3 drops already form a significant part of the finally produced brewed drink.
   In an embodiment, the extraction-side piercing tip is positioned in a region of the arching which is accessible from the outside, without the cover element being pierced.
   Supplementarily, it is also possible for the cover element not to be deformed due to the positioning of the extraction-side piercing tip.
   Supplementarily or alternatively, the cover element does not come into contact with the extraction-side piercing device, in particular its piercing tip, during the step of the positioning of the extraction side piercing tip in a region of the arching which is accessible from the outside.
Introducing a brewing fluid into the interior of the portion capsule, wherein the introducing of the brewing fluid causes a flattening of the arching directed into the interior.
The arching and its flattening can be as is described in the context of the portion capsule and the drinks machine.
The introducing of the brewing fluid is effected in particular via the injection-side piercing device.
The step of introducing a brewing fluid into the interior can activate one or more of the following effects which can cause the flattening of the arching:
   An increase of the pressure in the interior.
   A relative movement of a filter element which is arranged in the interior and which separates an extraction material region from that cover element which includes the initial arching, wherein the relative movement is in the direction of the cover element which includes the arching.
   Concerning embodiments of the method which include the mentioned relative movement, the portion capsule which is provided in particular is one of the previously described portion capsules with a filter element arranged in the interior.
The movement or deformation of the cover element or a part thereof, which is entailed by the flattening of the arching, in many embodiments leads to a relative movement between the mentioned cover element or the mentioned part thereof, and an extraction-side piercing device, in particular an extraction-side piercing tip. This relative movement corresponds to a movement of the extraction-side piercing device in the direction of the interior.
As a rule, it is the cover element or a part thereof which moves, whilst the extraction-side piercing device, in particular its piercing tip, for example relative to other parts of the drinks preparation machine, does not move.
In particular, the relative movement can correspond to a movement of the extraction-side piercing device in the direction of the interior, since the mentioned cover element or the mentioned part thereof moves towards the piercing device. In other words the relative movement can correspond to a movement of the extraction-side piercing device in the direction of the interior since the interior expands in the direction of the piercing device.

In an embodiment, the method includes the aforementioned steps of inserting the portion capsule into a brewing chamber, closing the brewing chamber and introducing a brewing fluid into the interior of the portion capsule, wherein the introducing of the brewing fluid creates a flattening of the arching which is directed into the interior.

Concerning the method according to this embodiment, the flattening can only be caused by the increase of the pressure in the interior or by the increase of the pressure in the interior in combination with the relative movement of the filter element which is arranged in the interior, in the direction of the cover element which at the beginning has the initial arching, for example as described above.

Supplementarily or alternatively, concerning the method according to the previously mentioned embodiment, the flattening of the arching can effect the previously mentioned relative movement between the cover element which at the beginning of the method has the initial arching, or a part thereof, and the extraction-side piercing device, in particular the extraction-side piercing tip.

The method according to any one of the embodiments can include features which correspond to the features of the portion capsule and/or the drinks preparation machine or are adapted to these features.

### BRIEF DESCRIPTION OF THE DRAWINGS

Embodiment examples are described hereinafter by way of figures. There are shown in:

FIG. 1 an exemplary portion capsule after its introduction into a brewing chamber and the closing of the brewing chamber, in cross section;

FIG. 2 the portion capsule according to FIG. 1 during the brewing process;

FIG. 3 an exemplary portion capsule and a brewing module part which is adapted to the portion capsule, after the introduction of the portion capsule into the mentioned brewing module part, in cross section; and

FIG. 4 the portion capsule and the brewing module part according to FIG. 3, during the brewing process.

### DETAILED DESCRIPTION OF THE INVENTION

The same reference numerals denote equal or analogous elements in the figures.

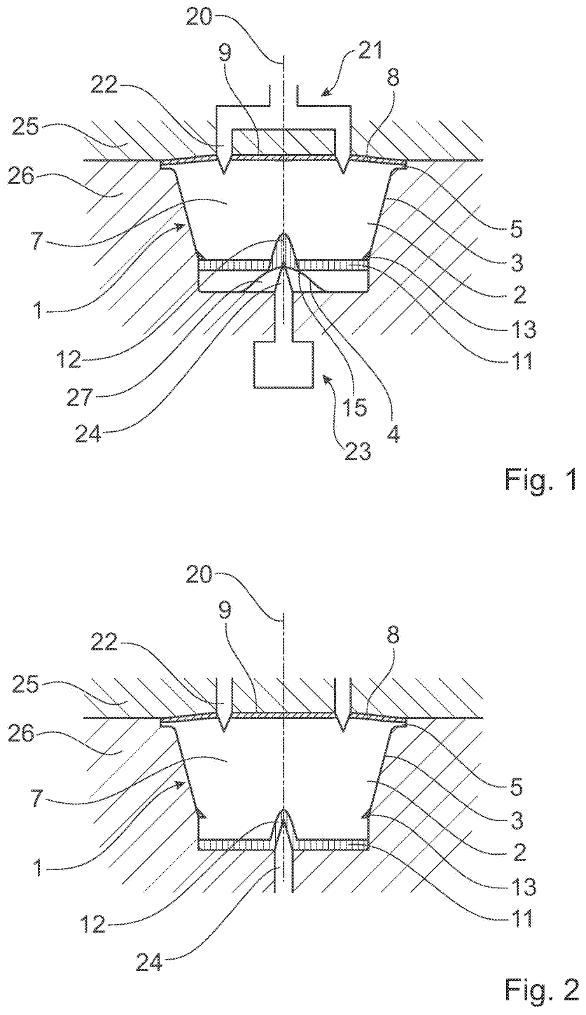

The exemplary portion capsule 1 according to FIG. 1 includes a base element 2 in the form of a beaker. The base element is shaped by a peripheral side wall 3 and a first cover element which in the shown embodiment forms a capsule bottom 4.

In the shown embodiment, the base element is formed of one piece from the peripheral side wall 3 and the capsule bottom 4.

The base element 2 includes a peripheral flange 5 and a second cover element which is fastened thereto. In the shown embodiment, the second cover element is a lid element 8.

The base element together with the lid 9 which is formed by the lid element 8 forms an outer capsule wall which defines a capsule interior 7.

The fastening of the lid element 8 to the base element 2 can be carried out in a manner known per se, for example by way of ultrasound welding, a thermal method or possibly by way of bonding.

In the shown embodiment, a brewed drink which is prepared in the capsule interior 7 is led away via the capsule bottom. Accordingly, the capsule bottom 4 includes an arching 15 directed into the interior 7 and accordingly at least the capsule bottom is of a biologically degradable material, for example of a bio-plastic, such as for example Terrablend, Arboblend or PLA, or from another brittle plastic.

In the case that the brewing fluid is introduced via the capsule bottom 4 and the brewed drink which is prepared in the capsule interior 7 is discharged via the lid element 8, the cover element 8 includes the arching 15 at the location of the capsule bottom 4 and the biologically degradable material. The subsequently described features relating to the discharge of the brewed drink change accordingly, wherein in particular these can be the features of the portion capsule 1 and/or the brewing module.

In the shown embodiment, the complete portion capsule 1 is manufactured of a biologically degradable material.

The portion capsule which is shown in FIG. 1 is shown within a brewing chamber which is formed by a first brewing module part 25 and a second brewing module part 26 which is movable relative to this. The brewing chamber is shown in the closed state, which is to say that the portion capsule 1 assumes its brewing position. However, in the configuration which is shown in FIG. 1 the brewing process has not yet begun. This means that the brewing fluid has not yet been introduced into the interior 7.

In the shown embodiment, the brewing chamber is deformed in the region of the arching 15 in a manner such that a free space 27, which is to say a non-filled space (cavity) arises when the portion capsule is located in the brewing position and the brewing process has not yet been started. Thanks to this free space 27, the arching can flatten when the brewing fluid is introduced into the interior 7.

In particular, the second brewing module part 26 is shaped in a manner such that the free space 27 arises.

The extraction-side piercing tip 24 is arranged in the free space 27. By way of this, the extraction side piercing tip 21 penetrates into the interior 7 as soon as the arching 15 flattens.

In the shown embodiment, the first brewing module part 25 includes an injection-side piercing device 21 with at least one injection-side piercing tip 22 and the second brewing module part 26 an extraction-side piercing device 23 with at least one extraction-side piercing tip 24.

In particular with embodiments with a filter element 11 which is arranged in the interior 7, as is shown in FIG. 1, the extraction-side piercing device 23 can include precisely one extraction-side piercing tip 23. As a rule, this is arranged along the longitudinal axis 20 of the portion capsule 1.

In the embodiment which is shown in FIG. 1, the injection-side piercing device 21 includes two injection-side piercing tips 22. However, more injection-side piercing tips 22 are also conceivable, for example three or four. The number of injection-side piercing tips 22 can be matched to the base shape. However, only one injection-side piercing tip 22 is also conceivable. In particular, this can be the case if the portion capsule includes a distribution element for an introduced brewing fluid, which is arranged in the interior.

In the embodiment which is shown in FIG. 1, the first brewing module part 25, in particular its injection-side piercing device 21, and the second brewing module part 26, in particular the extraction-side piercing device 23 are matched to the shape of the portion capsule 1 such that the injection-side piercing tips 22 penetrate the cover element 8, while the extraction-side piercing tip 24 comes to lie in the arching 15 of the capsule bottom 4, but at the most pricks the capsule bottom but does not pierce through it when the portion capsule 1 is located in the brewing position and the brewing process has not yet been started.

A configuration, in which the extraction-side piercing tip 24 does not pierce through the capsule bottom 4 or the cover element, via which the brewed drink is discharged out of the portion capsule is particularly advantageous with extraction-side piercing devices 23, concerning which the brewed drink is led away past the piercing tip 24. This is to say given configurations, concerning which the piercing tip or piercing tips 22 primarily have a function of piercing but not a discharging via a conduit arranged in their inside. It is particularly with such configurations that one can optionally make do without a central element 12 as is described hereinafter.

A configuration, in which the extraction-side piercing tip 24 does not pierce through the capsule bottom 4 or the cover element, via which the brewed drink is discharged out of the portion capsule is also advantageous with extraction-side piercing devices 23, concerning which the piercing tip or piercing tips 22 primarily scribe, in order to open the portion capsule at the extraction side or to initiate the opening of this during the brewing process, wherein the piercing tip(s) have no function which is directly related to the discharge of the brewing fluid, for example by a discharge along their surface(s) or via a conduit which is arranged in their inside(s). Given such configurations, a central element as described hereinafter can generally be done away with.

As already mentioned, the portion capsule 1 which is shown in FIG. 1 includes a filter element 11. This includes a central element 12 in the shown embodiment. This is arranged along the longitudinal axis 20 of the portion capsule 1 and has a base shape which is rotationally symmetrical with respect to the longitudinal axis 20.

The portion capsule 1 which is shown in FIG. 1 for example is a portion capsule concerning which a movement of the filter element 11 towards the arching 15 at least contributes to the flattening of the arching. For this reason, the portion capsule 1 in its interior 7 has no structure which prevents a moving of the filter element 11 in the direction of the capsule bottom 4.

However, means which ensure that a collection region 16 also forms after the moving of the filter element 11 can be provided in the brewing module, in particular its wall which faces the capsule bottom.

In the shown embodiment, an undesired moving of the filter element 11 against the lid element 8 is prevented by a positioning device 13 in the form of a peripheral projection which projects into the interior 7.

The situation during the brewing process which is to say after this has been started is shown in FIG. 2.

The introduction of the brewing fluid via the injection-side piercing tips 22 has led to the capsule bottom 4 having been deformed amid the action of a pressure which is increased in the interior 7 and the action of a force which is exerted by the filter element 11 upon the arching 15. In particular, the arching has flattened in the direction of the extraction-side piercing tip 24, by which means the extraction-side piercing tip 24 has penetrated into the interior, expressed more precisely into the central element 12 of the filter element 11. By way of this, the brewed drink can now be discharged out of the portion capsule 1 via the central element 12 and the extraction-side piercing tip 24, for example via a channel which lies at the inside in the piercing tip 24 or along the piercing tip 24.

What is not represented in FIG. 2 is the collection region 16, in which the brewed drink collects after passage through the filter element 11 and is fed to the central element 15.

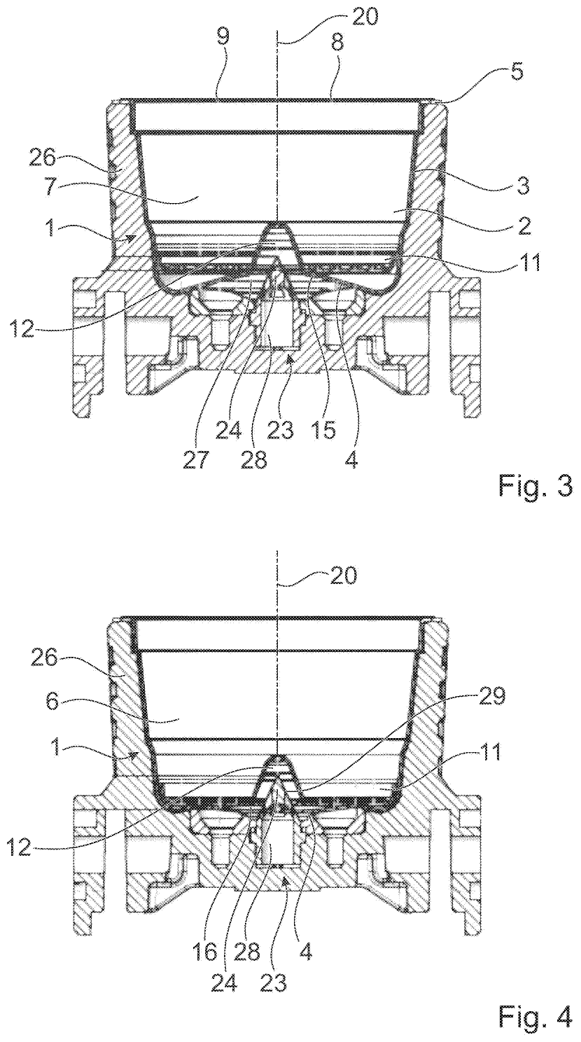

FIGS. 3 and 4 show a portion capsule 1 which is brought into a brewing chamber, and a brewing module part 26 which is adapted to the portion capsule 1 and which differs from the configuration according to FIGS. 1 and 2 as described hereinafter.

The injection-side part of the brewing chamber (which is to say the first brewing module part 25 in the shown embodiment) has been omitted in the FIGS. 3 and 4.

The portion capsule 1 is again shown located in the brewing position, wherein in the configuration which is shown in FIG. 3 the brewing process has not yet been started and the brewing process is running in the configuration which is shown in FIG. 4.

The configuration which is shown in FIGS. 3 and 4 differs from the configurations which are shown in FIGS. 1 and 2 in particular in the following points:
The extraction-side piercing tip 24 is arranged in a deepening of the wall of the brewing chamber. By way of this, not only can the arching 15 flatten, but it can fold over from projecting into the interior 7 (FIG. 3) to projecting out of the interior 7 (FIG. 4). By way of this, a collection region 16 forms also after the deformation of the capsule bottom 4 and the moving of the filter element 11 in the direction of the capsule bottom 4, as is shown in FIG. 4.
The extraction-side piercing device 23 includes an extraction-side piercing tip 24 with an inner-lying channel 28 and a channel opening 29 in the region of the tip of the piercing tip 24.
It is self-evident that the extraction-side piercing tip 24 can include a multitude of channel openings which run out in the inner-lying channel 28.
On account of this construction of the extraction-side piercing device 23 and the discharge of the brewed drink through the channel 28 of the piercing tip 24 which is entailed by this, the piercing tip 24 can already penetrate through the capsule bottom 4 when the portion capsule 1 is in the brewing position and the brewing process has not yet been started (FIG. 3). The piercing tip 24 should simply not penetrate so far into the interior 7 that the channel opening 29 comes to lie in the interior before the conditions which are necessary for the brewing process, in particular pressure and temperature prevail in the interior.
The extraction-side piercing tip 24, in particular the position of the channel opening 29 is adapted to the portion capsule 1 and the shape of the brewing chamber, in particular to the shape of the capsule bottom 4 after its deformation, such that after the deformation of the capsule bottom, which is to say during the brewing process, the channel opening 29 is located in an end region of the central element 12 which is at the channel base side (FIG. 4).

1. A portion capsule comprising a peripheral side wall, a first cover element and a second cover element, wherein the peripheral side wall, the first cover element and the second cover element form a closed interior, wherein the first cover element and/or the second cover element comprises an arching directed into the interior and wherein the cover element which comprises the arching is manufactured of a biologically degradable material,
wherein the portion capsule comprises a filter element which is arranged in the interior and which separates an extraction material region from the first cover element or from the second cover element, wherein the cover element which, by the filter element, is separated from the extraction material region comprises the arching directed into the interior,
wherein the portion capsule comprises a positioning device for the filter element, wherein the positioning device is arranged relative to the filter element in such a way that a movement of the filter element in the direction of the cover element which, by the filter element, is separated from the extraction material region is not prevented.

2. The portion capsule according to claim 1, wherein the positioning device is arranged relative to the filter element in a manner such that a movement of the filter element in the direction of the cover element which, by the filter element, is not separated from the extraction material region is prevented.

3. The portion capsule according to claim 1, comprising a base element which comprises the peripheral side wall and one of the two cover elements, wherein the other of the two cover elements is fastened to the base element and together with the base element forms the interior.

4. The portion capsule according to claim 3, wherein the base element forms a peripheral flange and said other of the two cover elements is fastened to the base element along the peripheral flange.

5. The portion capsule according to claim 1, wherein the portion capsule has a rectangular base shape, in particular a square base shape.

6. A method for the operation of a drinks preparation machine comprising the step of:
providing a portion capsule according to claim 1.

7. The method according to claim 6, comprising the steps of:
inserting the portion capsule into a brewing chamber of the drinks preparation machine, wherein the brewing chamber is formed by a first brewing module part and a second brewing module part which is movable relative to the first brewing module part;
closing the brewing chamber by way of the second brewing module part being moved relative to the first brewing module part;
introducing a brewing fluid into the interior of the portion capsule; wherein the introducing of the brewing fluid flattens the arching directed into the interior.

8. The method according to claim 7, wherein the flattening of the arching is caused by at least one of the following effects:
an increase of the pressure in the interior;
a relative movement of a filter element which is arranged in the interior and which separates an extraction material region from the cover element which comprises the arching, wherein the relative movement is in the direction of the cover element comprising the arching.

9. The method according to claim 7, wherein the movement of the cover element or a part thereof which is entailed by the flattening leads to a relative movement between said cover element or said part thereof and an extraction-side piercing device, wherein the relative movement corresponds to a movement of the extraction-side piercing device in the direction of the interior.

10. The method according to claim 9, wherein the extraction-side piercing device moves relatively in the direction of the interior due to said cover element or said part thereof moving towards the piecing device.

11. A drinks preparation machine for preparing a drink from a portion capsule according to claim 1, comprising a brewing module having a first brewing module part and a second brewing module part which is movable relative to the first brewing module part, wherein a brewing chamber is formable by the first and the second brewing module part, said brewing chamber at least partly surrounding the portion capsule which, during the brewing procedure, is located in a brewing position and being formed by a wall of the first and/or second brewing module part, wherein the brewing module is configured to brew a brewed drink by way of introducing a brewing fluid into the portion capsule and to discharge the brewed drink out of the brewing module via an extraction-side piercing device;
wherein an extraction-side piercing tip of the extraction-side piercing device is arranged in a deepening of the wall.

12. The drinks preparation machine according to claim 11, wherein the extraction-side piercing tip projects into the brewing chamber beyond an edge of the deepening.

13. The drinks preparation machine according to claim 11, wherein the deepening of the wall extending laterally to an axial axis of the extraction side piercing tip and beyond a width of the extraction-side piercing tip.
